(19) United States
(12) Patent Application Publication
(10) Pub. No.: US 2011/0066676 A1
(43) Pub. Date: Mar. 17, 2011

(54) Method and system for reducing web page download time

(75) Inventors: Vadim Kleyzit, Marlboro, NJ (US); Max Kleyzit, Marlboro, NJ (US)

(73) Assignee: VADIM KLEYZIT, MARLBORO, NJ (US)

(21) Appl. No.: 12/807,649

(22) Filed: Sep. 10, 2010

Related U.S. Application Data
(60) Provisional application No. 61/276,625, filed on Sep. 14, 2009.

(51) Int. Cl. G06F 15/16

(52) U.S. Cl. 709/203

(57) ABSTRACT

In one embodiment web page response time is improved by requesting multiple resources in a batch request, receiving said resources in a batch response, and disjoining the resources and corresponding HTTP headers before caching on the client. The resources are retrieved by web browser from the cache separately without loss of cache granularity. Client parses base page to determine the embedded resources and includes in the batch requests only web addresses those resources that are uncached or may be expired. To reduce required bandwidth, server validates caching information of every resource before sending the batch response. In another embodiment web application performance for mobile users is improved by combining individually requested resources into the batch response on a network node positioned on a link between cellular network and the Internet.

This application claims the benefit of U.S. Provisional Application No. 61/276,625, filed on Sep. 14, 2009

### FIELD OF INVENTION

This invention relates to systems and methods for increasing performance of web sites and web applications. More particularly the invention relates to systems and methods for reducing web pages download time and improving efficiency of web content caching.

### BACKGROUND ON THE INVENTION

Performance continues to be an important challenge for many web systems such as e-commerce and content sites, Software as a Service (SaaS) and mobile applications, and other web sites and web systems collectively called here “web applications”. Maintaining adequate response time of web page remains one of the most important factors impacting web application usability and end-user experience. In business web applications, long wait time leads to loss of users' productivity and even missing some business goals. In e-commerce web sites, delay in page response creates a less pleasant shopping experience and increases unrealized online purchases. In content web sites, slow page response causes diminished visitors' loyalty and traffic reduction.

A typical web application operates via Internet, intranet or other computer network that includes multiple interconnected devices located on network nodes (nodes), and has at least one server and client. The server serves web pages in response to client requests, and the client presents them in a web browser. The web browser has caching capabilities. Computer network can also include client caching nodes such as proxy servers, which are situated between server and client, but closer to the latter in terms of network distance. For example, in corporate wide-area network (WAN), where a central server is located in a data center and clients are located in a branch office, a client caching node is placed on the branch office local area network (LAN) on a network link connecting the branch office with the corporate WAN. Another example of a client caching node is a caching server situated on the edge of the Internet in content delivery networks (CDN), where clients access data from the closest caching server. The computer network can also include a reverse proxy server, typically positioned in front of a web server farm.

A typical web page, also called a web document, consists of a base markup page (base page), for example HTML page, and multiple supporting web resources or objects. Resources can be of different types, such as scripts (e.g. JavaScript), data resources (e.g. XML or other text-based data), style sheets, images and other page components. There are many image formats such as GIF, PNG, and JPEG. Each resource has a web address represented in the form of Uniform Resource Locator (URL). The base page references every resource by its respective web addresses. Resource can have more than one web address. Resources can reference other resources. Such resources are called here “parent web documents”. Term “parent web document” for the purpose of this invention means resources containing script or markup data referencing other resources, for example, a style sheet containing web addresses of several images.

When a web browser navigates to a web page, it first requests and fetches the base page using HTTP protocol. After receiving the base page from the server, the web browser parses it, and renders or generates its Document Object Model (DOM). While parsing the base page the web browser discovers references to the embedded resources and individually requests every discovered resource by its web address typically using HTTP GET message format. While parsing the base page, the web browser executes its inline and/or external script that can also initiate resource downloads using script API.

After all necessary resources are received, the web browser completes rendering DOM, presents the web page to the end-user and fires a designated event such as window.onload or body.onload. Time between requesting the base page and firing such designated event, is called page response time that is broken down into back-end time and front-end time. Back-end time starts when base page is requested and ends when the last byte of the base page is received, at which point the front-end time starts. The front-end time includes steps of requesting and downloading resources, parsing script and style sheets, executing scripts and rendering DOM. It ends when document window.onload event or a similar event is fired.

With the advance of Web 2.0, web page lifecycle became more complex. After the window.onload event, web browser can send additional AJAX requests that cause rendering additional elements of the same web document DOM or re-rendering (updating) some of the existing DOM elements. Web browser receives AJAX responses, parses and injects received markup data (e.g. HTML, XML or JSON) into the existing DOM and individually requests additionally discovered resources. Requesting some of the web resources requires user actions. For example, download of PDF documents, video, audio and streaming media objects or other web pages, referenced by HTML links, starts after user clicks such links. User interaction with the web page can also launch script execution that initiates loading more web resources. The term “web page resource” (resource) for the purpose of this invention means web object which has a web address and can be requested by the base page or parent web document.

Resources are originated on the server. They can be created in advance of receiving an HTTP request, for example, in design time, or at the time of periodic web site updates. In this case, resource may be stored on the server as a file (file-based resource). When the file-based resource is requested by the client, the server includes the content of the resource file into the HTTP response. An example of the file-based resource is a static image file on the server. If file-based resource never changes on the server it is called “static resource”. File-based resources rarely stay unchanged indefinitely and typically sooner or later will change as a result of web site content update. Resources, which are updated more frequently than others, are called dynamic resources, as opposed to semi-static or semi-dynamic resources that are less volatile.

Alternatively, a resource can be generated dynamically, while processing HTTP request. The term “dynamically generated resource” should not be confused with the “dynamic resource” discussed in the previous paragraph. The former denotes a resource created while processing a request by a handler or program that is likely to retrieve data from a database. For example, a graph image reflecting constantly changing value of an investment portfolio is generated “on-the-fly” after receiving a request. Once the image is sent to the requesting client, its copy on the server is destroyed. The server can have one designated handler for generating images and another designated handler for generating scripts. The client can request dynamically generated resources using the handler web address and optional request parameters such as a query string or a post request form. For example, web applications developed using ASP.NET AJAX technology can use WebResource.axd and ScriptResource.axd handlers for different types of dynamically generated resources. Resource that is used for servicing requests from many clients is called here “shared resource”. File-based resources are more likely to be shared resources, while dynamically generated resources, especially those which include user specific request parameters, are less likely to be shared resources. If there is an expectation that the same version of the resource can be requested more than once, it can be beneficial to cache it on the server in order to save server time of recreating this resource on subsequent requests. However, typically caching time of dynamically generated resources is short, and there is a risk that server caching can cause sending to the client stale information.

### The Problem

Front-end time is prolonged by several factors that slow down web page response. Despite the ability to maintain several concurrent network connections in modern web browsers, multiple web page resources are fetched from the server successively. Web browser generates a separate HTTP request for each resource. Multiple HTTP requests create server and network overhead. Network latency is caused by network chatter between the server and client, because many relatively small files are shipped over the computer network. Small files are transferred using small HTTP packets that prevent from achieving full bandwidth utilization and results in degrading end-user experience even in high throughput network. Multiple HTTP requests also cause server overhead that leads to increasing download time and specifically to higher front-end time.

Besides network and server limitations, there are some web browser specific factors that impact page performance. Web browser can establish limited number of connections per web domain and overall. For example, in HTTP/1.1 Internet Explorer (IE) 6 and 7 and Firefox 2 are limited to two connections per domain, Safari 3 and 4 and Opera 9 are limited to four connections, IE 8, Firefox 3, and Chrome 1, 2 are limited to six connections [Roundup on Parallel Connections. High Performance Web sites blog http://www.stevesouders.com/blog/2008/03/20/roundup-on-parallel-connections/]. Once the maximum number of concurrent connections is reached, the other requested resources are queued until download of the previous resources is complete. Parsing large base pages, building DOM and executing script requires some time, which causes delays in requesting resources. Certain operations in web browser cause blocking of all downloads. For example, when JavaScript resource is being downloaded and parsed, it blocks requests of all other resources, even if maximum number of browser concurrent connections is not reached. Processing JavaScript also blocks DOM rendering that further slows down web page response.

In Web 2.0 applications front-end time has a tendency to be higher due to a larger number of resources on the base page. Rich web pages use more images and style sheets, while AJAX pages use more scripts. Increasing complexity of web pages and sophistication in developmental tools and techniques leads to a higher level of web page modularity. A typical web page can have 50-70 resources on average. 80-90% of the end-user response time is spent on the front-end [Steve Souders. High performance web sites. O'Reilly, 2007]. The last parameter depends on the number of factors such as the number and size of the resources on the web page, frequency of resource updates, size of the base page, state of the browser cache (empty or primed), utilized caching solution such as CDN or caching proxy, time to deliver each of the resource, called round-trip time (RTT) and available network bandwidth.

On subsequent requests of the same web page some of the cached resources are retrieved from the cache without round-trip to the server. However, when the number of resources on the base page is large, it causes multiple cache reads that slow down web page rendering in the browser.

It is desirable that user can access the updated version of the resource on his/her very first visit to the web site after the resource has been updated. However, the web browser can sometimes present a stale version of the resource. It happens due to imperfections of existing caching mechanisms or caching misconfiguration. In this case, stale content is presented to the user until it is replaced by the updated content from the server. In some cases presenting stale content can cause serious consequences. For example, when a web page displays volatile business information in graphical form, an up-to-date version of the dynamic image must be presented to the end-user. Therefore client cache utilization should not prevent the web page from requesting current versions of resources.

### Existing Solutions

There are several existing solutions to alleviate these limitations. One solution (US Patent Application 20090217145) suggests reducing the number of page resources by combining resources of the same type into a larger aggregate object. Multiple JavaScript files are combined into a single script file, multiple style sheets are combined into a single style sheet and multiple images of a particular type are combined into a single image of this type. The base page is adjusted accordingly to replace multiple individual resources references of a particular type with a single reference to the aggregate resource of this type. Each of such aggregate objects is handled by the web browser as a single resource that is cached on the client. Fewer aggregate resources reduce the number of network roundtrips. There are, however, several disadvantages in this approach:
a) It is more “expensive” to re-cache combined resources in terms of network traffic as compared to individual resources. When one out of many combined individual resources is changed, then the entire aggregate object has to be fetched from the server, which creates redundant data transfer. Also, small objects statistically change less frequently and can stay valid in the cache longer than large aggregate objects. For that reason, combining resources in this solution can in some cases increase response time.
b) This solution reduces client cache granularity and efficiency, because resources shared by different web pages are loaded to client multiple times. For example, if several base pages reference the same individual resource, e.g. company logo image, then this image is loaded and cached on the client once and then reused by multiple web pages. However, this resource combining solution requires to include the company logo image into the aggregate image for every page. This leads to redundant network traffic.
c) Objects of different types (e.g. images and scripts) cannot be combined.
d) The recommendation of combining resources conflicts with the trend of modular development. The process of combining is largely manual and labor-intensive. It requires changing resource references in scripting files, style sheets and base page script that can impact the original parsing order of web page markup. This bears risk of breaking web page script execution or altering web page behavior and presentation. To reduce such risk only consecutive scripts are combined. This leads to an increased number of aggregate objects and reduces effectiveness of this approach.
e) Combining resources automatically is difficult to implement, especially for images, and existing automatic solutions provide relatively low ratio of resource consolidation (ratio of combined resources to a total number of resources on a web page). Combining resources manually is a labor-intensive process.
f) Some methods of embedding inline images create overheads. For example, embedding inline images into web page, or style sheet, using base64 encoding increases combined payload.
g) In dynamically generated base pages the operation of altering base page HTML to reflect references to aggregate resources is performed on the server on every request, which creates an additional workload that slows down the server.

Another solution reduces web page response times on subsequent requests by utilizing caching. Each resource loaded on the initial request can be stored in the client cache (e.g. web browser cache) and/or client caching node, according to its caching rules specified in certain HTTP response headers. The resource is cached along with its versioning information, such as time of creation (e.g. Last-Modified header), or a hash of the resource object (e.g. ETag header). On subsequent requests, if cached content is fresh, it is served to the web page more expeditiously. There are several approaches to determine the validity of the cached content. For example, the web browser sends a conditional request with cache versioning information to the server. The server compares this versioning information with the server resource version. If the cached resource is valid then the server sends an empty response with the status code 304-Not-Modified indicating that object on the server was not changed, and web browser uses cached version of the resource on the web page. This allows reducing overall page response time, since empty response is small. However, a large number of conditional requests slows down web page because of network overheads.

Another existing solution enhances the previous solution by removing unnecessary conditional requests. The server includes resource expiration information in the response, indicating the expected time of the resource staying unchanged on the server. This information is typically included into the response Cache-Control or Expires header that is cached with the resource. The web browser does not send conditional requests for unexpired resources. However there are several disadvantages in this solution:
a) It is difficult, and often impossible, to accurately predict resource expiration time. If expiration time is estimated too optimistically (set to a too far future date), then it creates a risk of using stale cached content that causes a web application consistency problem. If the expiration date is estimated too pessimistically (set to a too close date), then the web browser will unnecessary initiate server roundtrip.
b) Setting an expiration date for all resources on a web site is an arguably complex management task, since the pattern of future resource changes is unpredictable.

The next solution has a goal to avoid presenting stale content by changing the resource web address or renaming resource files using a surrogate link after every resource change on the server. Since the renamed resource is not cached on the client it is requested from the server. However, synchronously renaming resources and all their references in all web pages on every update is arguably a complex management task that potentially can break web site integrity.

Another existing solution requires relocating JavaScript to the end of the base page to defer blocking page parsing and relocating style sheets to the beginning of the base page to allow requesting resources sooner. However, such manual changes in the base page are labor-intensive and potentially can break page script integrity.

### DRAWINGS AND FIGURES

FIG. 1A is a diagram showing web application in the prior art.

FIG. 1B is a diagram showing web application with client caching node and reverse proxy node in the prior art.

FIG. 1C is a diagram showing web application in WWAN settings in the prior art.

FIG. 2A is a diagram, showing the system for reducing web page download time in the preferred embodiment.

FIG. 2B is a diagram, showing the embodiment that uses caching and reverse proxy nodes of the invention.

FIG. 2C is a diagram showing the embodiment in WWAN settings of the invention.

FIG. 3 is a diagram, showing a flowchart of the invention method in the preferred embodiment.

FIG. 4 is a diagram, showing combining cached resources.

FIG. 5A is a waterfall diagram, showing downloading a test web page in the prior art.

FIG. 5B is a waterfall diagram, showing downloading the same test web page in the invention.

### SUMMARY OF THE INVENTION

In the view of the above limitations, some objects of the present invention are to avoid slow web page response caused by a large number of resources referenced by the base page, to reduce web traffic chattiness, to increase efficiency of bandwidth utilization, to avoid compromising web page integrity, and to eliminate additional web site development or maintenance work to manually combine resources. This is achieved by sending a batch request containing the web addresses of the multiple resources referenced by the base page, on the server separately processing individual requests to every web address, obtaining requested resources along with their respective response headers, combining said requested resources into the batch response, sending the batch response, and loading the resources into the web browsers separately.

It is a further object of the present invention to improve user experience through less time spent waiting for web page resources to be downloaded and to reduce number of network roundtrips delivering resources from the server to the web browser and specifically the number of conditional requests, as well as to reduce risk of stale content. This is further achieved by combining multiple resources of different types in one batch request/response sequence and by including into the batch request web addresses of the resources that are uncached or may be expired along with the cache versioning information of the latter, while excluding from the batch request web addresses of the resources that are cached and unexpired.

It is an additional object of the present invention to reduce required bandwidth for downloading webpage resources. This is further achieved by including into the batch response only those resources that are uncached or expired, as determined according to the cache versioning information from the client that is included in the batch request.

It is an additional object of the present invention to avoid compromising client cache granularity caused by caching combined resources. This is further achieved by including into the batch response a set of HTTP response headers for each of the multiple resources, and separately caching the resources from the batch response in association with the related sets of HTTP response headers.

It is an additional object of the present invention to gain maximum benefits from response compression while minimizing computation for compression and decompression. This is further achieved by combining in batch response compressed resources with the relatively high compression ratio and uncompressed resources whose compression ratio is relatively low.

It is an additional object of the present invention to avoid web server performance degradation caused by operations for combining resources. This is further achieved by parsing the base page and the parent web documents, if exist, on the client to determine the resource web addresses and send this information to the server in the batch request.

It is an additional object of the present invention to further reduce the number of network roundtrips to provide a higher ratio of resource consolidation by discovering more web page resources. This is further achieved by monitoring requests from the web browser originated by the web page. Monitoring the requests allows to detect some of the resources, which cannot be detected by parsing, for example, the resources requested as a result of web page script execution.

It is an additional object of the present invention to increase web application performance for mobile users. This is further achieved by forming the batch request on the client of the cellular network, and forming the batch response on a network node that services resources received from the Internet from a large number of servers.

It is an additional object of the present invention to provide a system that improves web page response time. This is further achieved by the system that comprising a batch request handler positioned on the server or on the network node and receiving a batch request containing web addresses of resources referenced by the base page; and a batch response handler receiving a batch response containing at least some of the resources, wherein said at least some of the resources loaded into the web browsers separately.

It is an additional object of the present invention to increase effectiveness of content delivery networks. This is further achieved by positioning and forming the batch request on a caching node of a content delivery network.

Additionally, the invention allows to speedup web page rendering in the web browser and reduce and expedite cache reads or accelerate receiving objects from caching node. This is achieved by combining some of the resources of the same type on the client or caching node and caching them on the client or caching node in a form of aggregate resource. Base page is modified accordingly to replace references to individual resources by a smaller number of references to aggregate resources.

### DESCRIPTION OF THE INVENTION

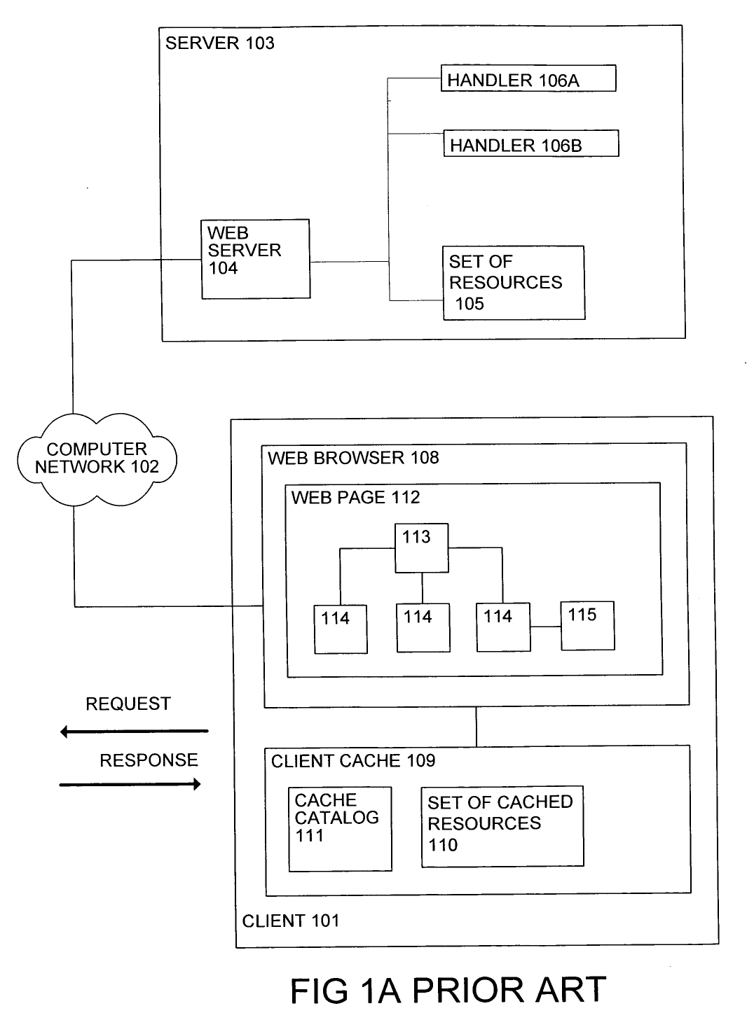

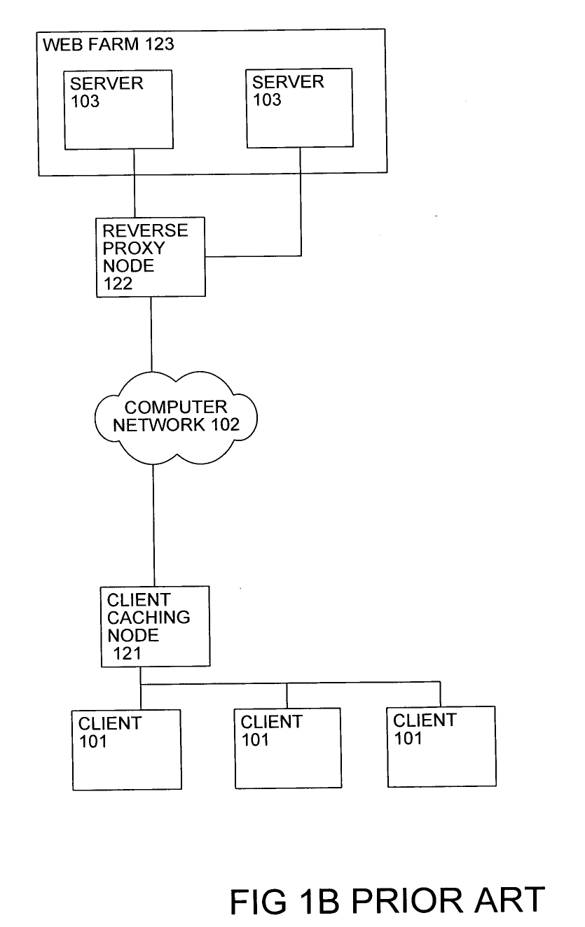

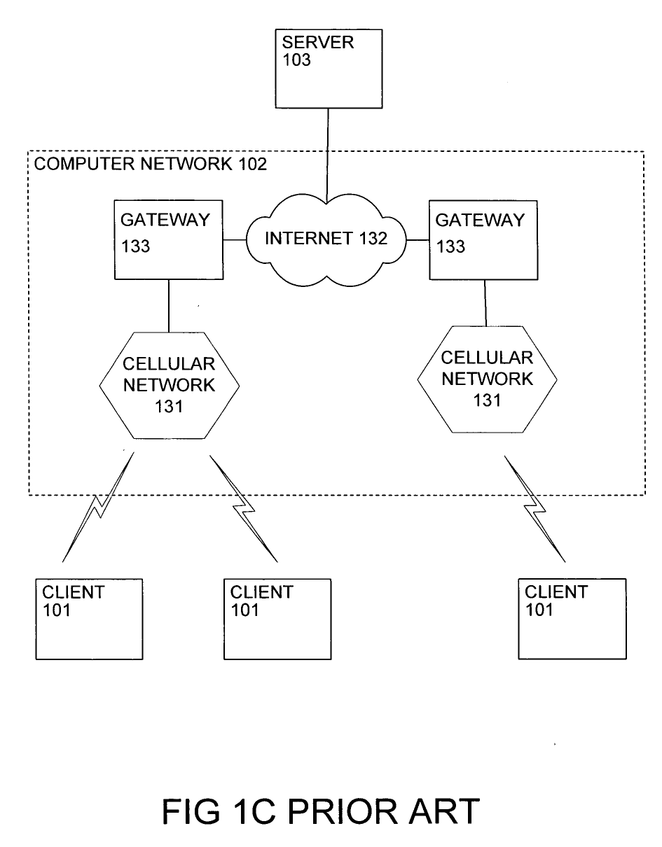

FIG. 1A shows a diagram of web application in prior art. A client computing device (client) 101 is communicatively connected via a computer network 102 to a server 103. Examples of client computing device include a desktop computer, notebook computer, PDA, smartphone and other devices that have at least one processing unit, system memory, and mass storage device such as hard drive, CD or DVD module or non-volatile memory card. The computer network can be the Internet, intranets, extranets, LAN, WAN, wireless network, wireless wide area network (WWAN) or some combination thereof. Server 103 has one or more processing units, system memory, one or more network adapters and mass storage devices, such as hard drives, CD or DVD module or non-volatile memory cards (not shown). Server 103 hosts web server 104 that receives HTTP requests (shown as REQUEST) from the client 101 and sends back HTTP responses (shown as RESPONSE). Although the HTTP protocol is described with reference to several embodiments, other network protocols, including without limitation S-HTTP, or any future communication protocols including ones that are oriented to handle batch requests and responses as described below, are contemplated within the scope of the present invention. In order to process certain type of requests web server 104 accesses resources in a set of resources 105 and invoke handlers 106A and 106B. A handler is a piece of program or object code that processes a particular type of message. Set of resources 105 can include file-based resources such as JavaScript files, style sheet files and image files. Each of the handlers 106 is designed to handle certain type of requests and dynamically generate certain type of resources (not shown). For example, handler 106A can generate dynamic scripts and handler 106B can generate dynamic images. Client 101 executes web browser 108 that communicates with a client cache 109 that stores cached resources 110. The client cache can be a browser cache. Client cache catalog 111 contains information about cached resources and is used for faster access. Web browser presents a web page 112 that consists of a base page 113 referencing resources 114. Some of the resources 114, which are called here “parent web documents”, reference other resources 115.

FIG. 1B shows a diagram of a web application with proxies in prior art that operates similarly to the previous prior art. An optional client caching node 121 is situated on the computer network 102 between the clients 101 and servers 103, but closer to the former in terms of network distance. HTTP traffic to the clients is passed through the node 121, which can cache resources in its internal cache (not shown). Cached resources can be used by multiple clients 101, each of which can also have cache 109 of their own (not shown). An optional reverse proxy node 122 is located in front of a web farm 123 of servers 103. The node 122 contains a reverse proxy (not shown) that performs various performance-enhancing functions such as server load balancing and caching, web traffic encryption, SSL acceleration and compression.

FIG. 1C shows a diagram of a mobile web application accessed via WWAN in prior art that operates similarly to the previous prior art. WWAN computer network 102 connects mobile clients 101, such as smartphones or notebook computers with a cellular network card, with the server 103. Cellular network 131 that is a part of the network 102 is interconnected with the Internet 132 via multiple gateways 133, such as base stations, that provide internet access to mobile clients. Client 101 hosts a mobile web browser (not shown) that communicates with the server using encoded in radio signal HTTP messages, through the cellular network 131 and gateway 133.

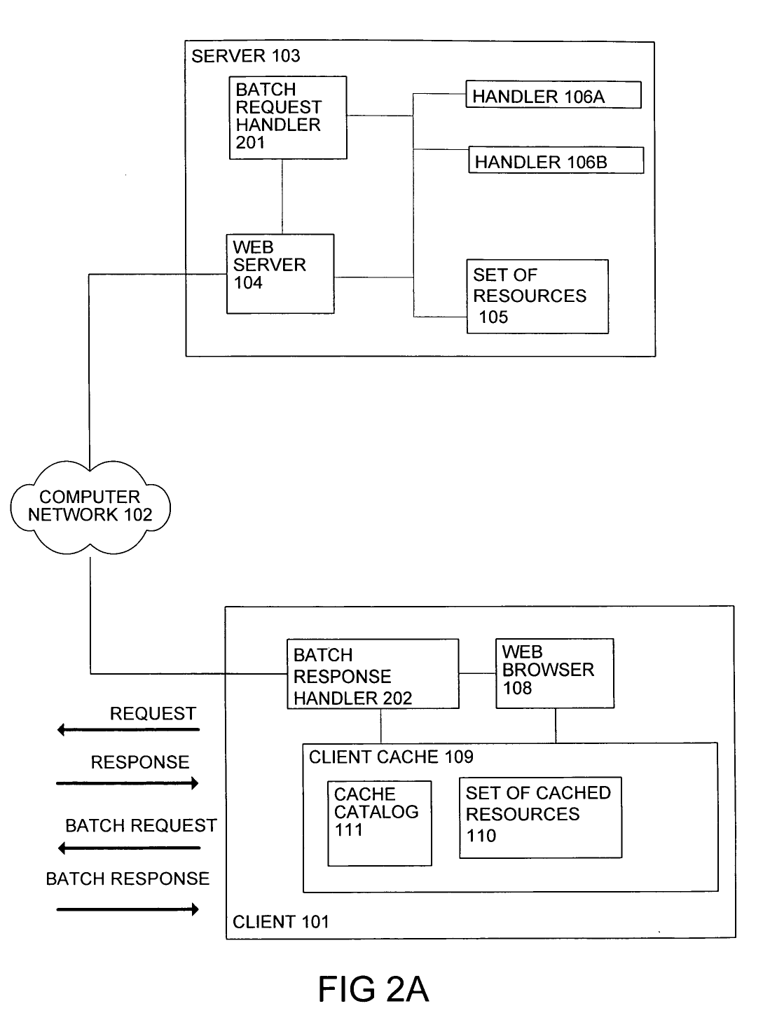

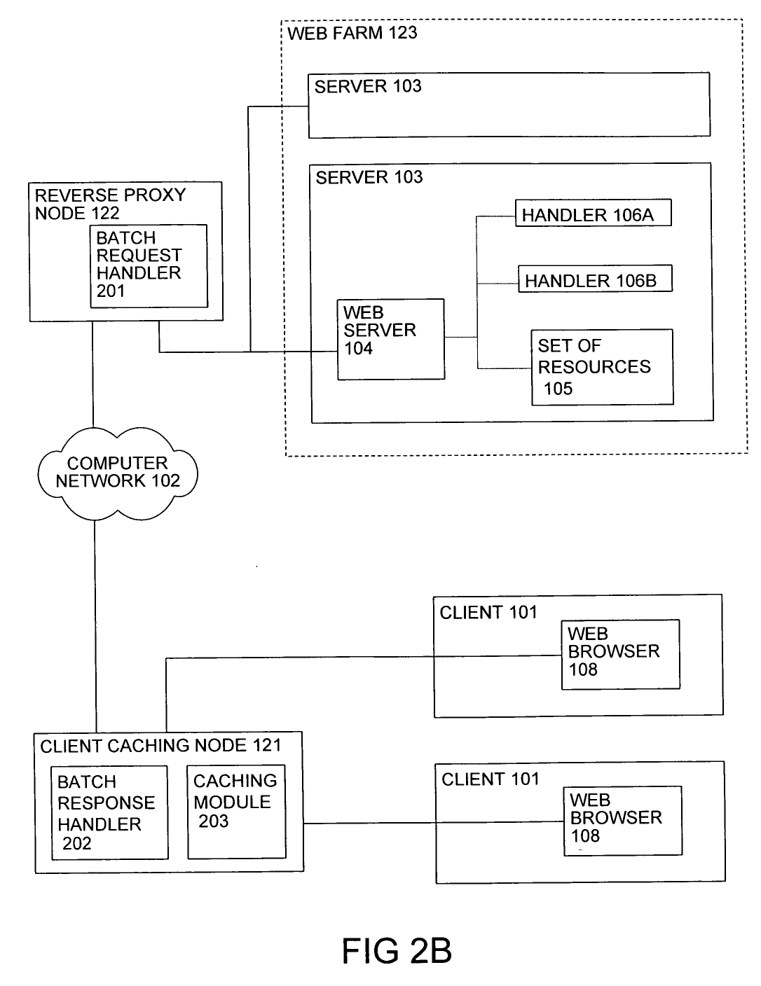

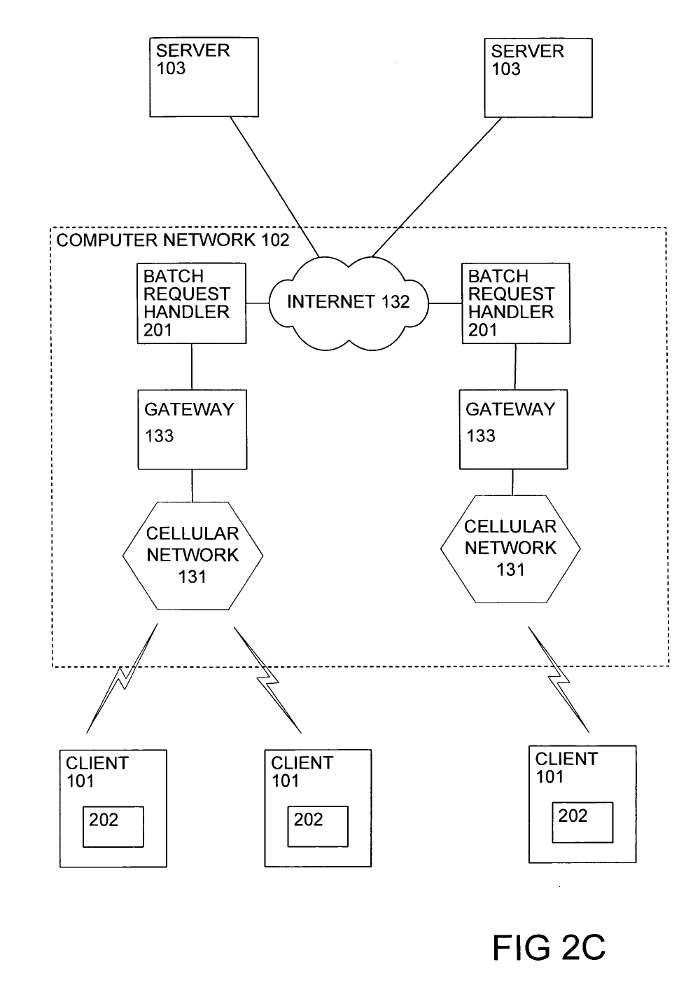

FIG. 2A shows a diagram of web application, according to preferred embodiment of the invention. It contains all the elements of the prior art shown on FIG. 1A that are connected and function similarly with the exceptions described below. Some of the elements from the FIG. 1A are not shown on the FIG. 2A. Web server 104 communicates with a batch request handler 201 for handling special type of HTTP batch requests. The batch request is an aggregate request for multiple resources described below. The batch request handler can be a program extension module, a software module embedded into a hardware appliance, a dynamic-link library (DLL), an assembly, an ASP.NET module or handler, an ISAPI filter, or other software unit containing programming instructions that may also be capable to instantiate and handle software objects performing specific functions. The handler 201 is embodied into a non-transitory computer-readable medium such as system memory or mass storage device. The handler 201 is designed to handle such batch request and generate a batch response that aggregates information of multiple resource responses according to the invention as described below. It can directly or through the web server 104 access the set of resources 105 and invoke handlers 106. In another embodiment, the handler 201 is implemented as an element of HTTP request/response pipeline that passes through the HTTP traffic routed through the web server. The handler 201 is located on this pipeline either before or after the web server 104.

Web browser 108 communicates with computer network 102 via handler 202 that is designed to send batch requests and receive batch responses according to the invention. The handler 202 can be a program extension module, a software module embedded into hardware appliance, a dynamic-link library (DLL), assembly, Active-X control, applet, browser plug-in, browser helper object, application-pluggable protocol, mime-filter or other software unit containing programming instructions that may also be capable to handle software objects performing specific functions. The handler 202 is embodied into a non-transitory computer-readable medium such as system memory or mass storage device. It can read and write to the client cache 109 using API. Examples of such API include WinINet API used to access IE cache and GECKO API used to access Firefox cache. The handler 202 can also be implemented as a part of the web browser 108. The base page network roundtrips are shown by traffic designators “REQUEST” and “RESPONSE”. The batch requests/response sequences are shown by traffic designators “BATCH REQUEST” and “BATCH RESPONSE”. In another embodiment the web browser can send requests bypassing the handler 202. In one more embodiment functions of sending batch request and handling batch response are implemented by two separate modules and functions of handling batch request and sending batch response are implemented by two separate modules.

FIG. 2B shows a diagram of a web application according to another embodiment of the invention. It contains all elements of the prior art shown on FIG. 1A that are connected and function similarly with the exceptions described below. Additionally, it contains the batch request handler 201 that is implemented as a module positioned on the reverse proxy node 122 outside server 103, which can work in conjunction with the web farm 123. Batch request handler 201 requests resources from the set 105 and invokes handlers 106 by sending HTTP requests to one or several web servers 104. The node 122 can be a server hosting reverse proxy, a network appliance positioned in front of the web farm or any other network node located between server and client that can act as a proxy. The handler 202 is implemented as a module of client caching node 121. It communicates with the caching module 203 on the same node via API that similarly to the client cache 109 (not shown) allows saving and retrieving resources of multiple web pages along with their response headers containing caching information. A single node 121 can serve multiple clients 101. Caching module 203 and the client cache operate as a hierarchical cache. In one example of this embodiment web farm 123 is located in a corporate data center, while the node 121 is placed in a branch office to increase web application performance for clients 101 located in this branch office. In another example of this embodiment node 121 is a part of CDN and is located on the edge of the Internet to accelerate clients 101 located in the network proximity to this node. In another embodiment (not shown) the batch request handler 201 is implemented as a module of the node 122, and the handler 202 is implemented as a module of the client 101. In one more embodiment (not shown) the batch request handler 201 is implemented as a module of the server 103, and the handler 202 is implemented as a module of the client caching node 121.

FIG. 2C shows an embodiment that contains all elements of the prior art shown on FIG. 1C that are connected and function similarly with the exceptions described below. It also contains the batch request handler 201, positioned on the link between the gateway 133 with the Internet 132, and the batch response handler 202 and client cache (not shown) positioned on the client 101. This embodiment accelerates mobile internet access for smartphone users by expeditious resource delivery via cellular network, which is typically a performance bottleneck in WWAN settings. Since no hardware or software installation or modifications is required on web application sites, this embodiment can be implemented by cellular phone service providers to accelerate access to web pages on a large number of servers. The phrase “large number of servers” means the number of server that is not restricted by only those sites that require to make hardware or software modifications, for example installing dedicated handler 201, to gain web application performance benefits of the invention.

### OPERATION OF THE INVENTION

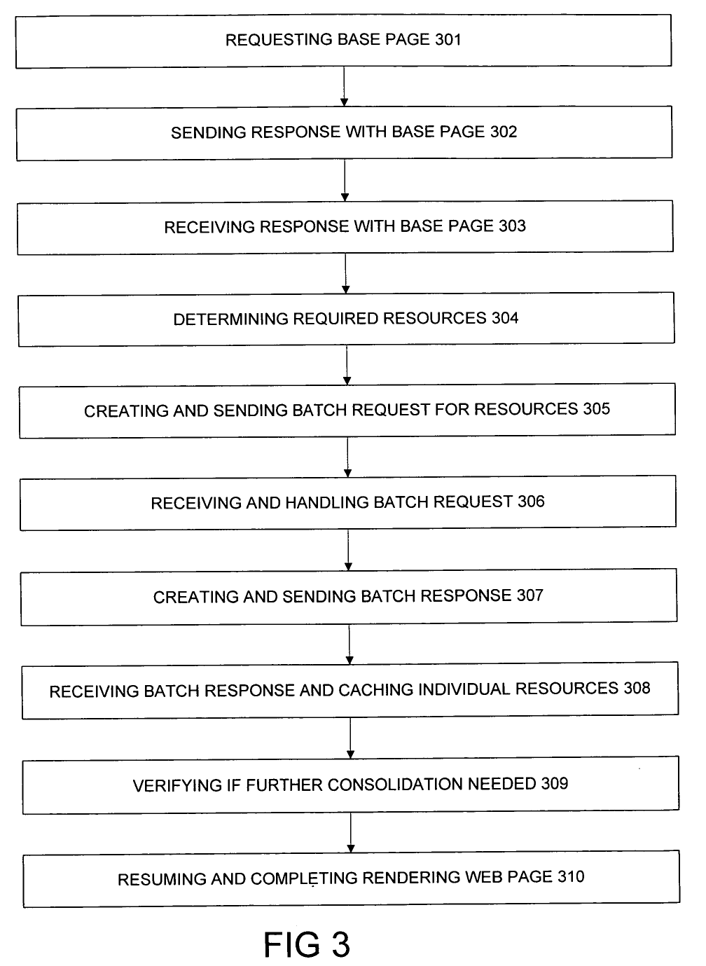

FIG. 3 shows a flowchart of operations of web application in preferred embodiment according to the invention method to expedite downloading web page resources.

Requesting base page 301. The web browser 108 requests the base page 113 from the server 103. It sends a request message with appropriate request information through the computer network 102 using HTTP protocol. If the batch response handler 202 is located on the client caching node 121, then the request message is routed through the node 121. If the batch request handler 201 is located on the node 122, then the request message can be routed through the node 122.

Sending response with base page 302. The server 103 receives the request and sends a response message with base page markup back to the web browser. If the request on the previous step was sent through the node 121 or 122, then the response is routed back through the same node.

Receiving response with base page 303. The handler 202 receives the response message with the base page and holds this message to delay the web browser handling of the base page until web page resources 114 and 115 are received from the server and cached in the client cache 109 or caching module 203. In the embodiment where the functions of handler 202 are performed by the web browser, the response is loaded to the web browser, however DOM rendering may be suspended until the necessary resources are downloaded and cached on the client. In another embodiment, handler 202 does not hold the base page and passes it through to the browser without a delay.

Determining required resources 304. The handler 202 determines what resources are embedded into the base page or other parent web documents and stores this information as an appropriate data structure, such as list or tree. One way to determine this information is to parse the base page. Base page script or markup, for example HTML, contains reference information, such as URL, sufficient to request such resources. Base page parsing is performed by using regular expressions that reflect HTML rules of referencing resources. For example HTML specification allows the following resource reference format:

<img src={IMAGE-RESOURCE-WEB-ADDRESS}>
<script src={SCRIPT-RESOURCE-WEB-ADDRESS}>
<link href={STYLESHEET-RESOURCE-WEB-ADDRESS}>,
where the text surrounded by “{” and “}” is the appropriate web address.
In a variation if this embodiment the list of required resources also includes HTML links that are marked for prefetching according to HTML 5 draft recommendation (http://www.whatwg.org/specs/web-apps/current-work/multipage/links.html).

In another embodiment the handler 201 parses the base page on the server to generate the list of embedded resources and includes this list into the base page response message. The handler 202 receives this response message and separates the list of resources from the base page information. In one more embodiment handler 202 collects and stores the information about resources embedded into the web page, without parsing, by monitoring requests initiated by the web browser once it has received and started handling the base page. In a different embodiment the list of embedded resources is created on the node 121, 122 or on the server 103 by monitoring requests from the base page. Such resources are recognized by request's Referrer header that contains the URL of the base page which reference was followed. If the list of resources is created on the server 103 or node 122, it is stored on the respective node and is included into the response on the subsequent base page requests from the same or different client. In one variation of this embodiment this list includes only shared resources.

Creating and sending batch request 305. The handler 202 creates one or several batch requests that include request information of multiple resources 114 of different types, which are embedded into the base page, as it was determined on the previous step. Web address of each resource is included into the batch request. If resource is cached in the cache 109 or 203, then its header information, such as Last-Modified, ETag, or other versioning information, is retrieved from the cache and included into the batch request. Such information is packaged into a body of HTTP POST message as a set of variable length records, where each record represents a particular resource. The POST message has an indication that this is a batch request, for example, it has a special HTTP request header or it is sent to a web address of the batch request handler 201.

In the embodiments, where the batch request handler 201 is bound to the server 103 or web farm 123 with several servers 103 (FIGS. 2A and 2B), the batch request contains only requests for the resources located on the servers 103. Resources hosted on different web domains are not included into the batch request. In the embodiments, where the batch request handler 201 is not bound to a specific hostnames (FIG. 2C), the batch request is not limited to include resource web addresses from only certain web domains. The post message of the batch request is compressed by the batch response handler 202. The batch request is sent via the network 102. If some of the embedded resources are missing and not added to the batch request, then such resources are handled as individual resources in prior art. Web page integrity is not compromised in this case.

In another embodiment the resources embedded into the base page are divided between several batch requests that are sent concurrently in order to take advantage of web browser capability to handle multiple parallel connections. In one more embodiment unexpired cached resources with Expires header are not included into the batch request. Batch requests speedup web pages only when the number of combined resources exceeds a certain minimum, for example 3 or 4. If the number of required resources does not exceed this threshold, then the batch request is not created and step 310 is executed next.

Receiving and handling batch request 306. The handler 201 receives the batch request, decompresses it, if it was previously compressed, extracts the information about the individual resources and initiates or processes every individual request asynchronously and concurrently. If the handler 201 is situated on the server 103 behind the web server 104, it directly accesses the requested resources from the resource set 105 and invokes targeted by the individual requests handlers 106. If the handler 201 is situated in front of the web server 104, either on the node 122 or on the server 103, it sends individual requests to the web server for resources from the set 105 or to invoke necessary handlers 106. Every individual response information is generated similarly to the prior art. For example, response information of a file-based resource contains a copy of such file and response headers, such as Cache-Control, ETag, Expires, Last-Modified and other HTTP response headers. Response information of a dynamically generated resource contains the similar headers and an object returned by the handler 106.

The handler 201 validates every resource cached on the client by comparing its cache versioning information with the server resource version. For example, it compares the request header, such as If-Modified-Since, with the resource file update timestamp. If the resource has not been updated on the server after If-Modified-Since timestamp then its response is not included into the batch response. Individual responses included into the batch response can be compressed and minified for faster network transmission.

Creating and sending batch response 307. The handler 201 combines header information and bodies of all individual responses into the batch response message body. Script and style sheet are minified before combining by removing unnecessary white spaces and comments. Also, response data of the resources with high data compression ratio, such as text-based scripts or style sheets, is compressed. Images and other binary data are not compressed. As a result, the batch response contains combination of compressed and uncompressed data to gain maximum benefit from its message size reduction, while minimizing computation for compression and decompression. After that, every individual resource response is presented as a record of a certain length. For example, each record can include resource web address, compression flag, its header section, consisting of delimited name/value pairs, and its content section with resource size followed by the actual resource content. The message body of the batch response is formed using known techniques of combining multiple variable length records. Alternatively, the batch response can contain a catalog of all the records followed by the actual records content. The same formatting convention is used by the handler 202 on the next step, when it performs reverse operation of disjoining individual resource responses from the batch response, including decompression of all compressed responses. Once the batch response is created, it is sent back to the handler 202 via the computer network 102. If some of the requested resources are missed and their requests are not added to the batch response, then such resources are handled as individual resources in the prior art. Web page integrity is not compromised in this case.

Receiving batch response and caching individual resources 308. The handler 202 receives the batch response and extracts from its message body the response information about individual resources. Then individual resources along with their header information are cached in the client cache 109 or caching module 203 according to their caching headers similarly to the prior art. Additionally, handler 202 adds a short duration Expires header to those cached resources, which don't have one, to suppress conditional server requests during the base page parsing in the web browser. In another embodiment conditional requests to such resources are intercepted by the handler 202 and are serviced from the client cache 109.

Verifying if further combining needed 309. Handler 202 verifies, whether received resources reference other resources, whose responses can be combined. Similarly to the step 304, it parses every resource that can potentially be a parent web document, for example style sheets, to determine what additional resources are required for this web page. If more resources can be combined, handler 202 similarly to the step 305 collects from the cache 109 or 203 any available resource caching information and, if necessary, forms another batch request, which excludes valid cached resources, and sends it to the server. After that, the batch response is received and additional resources are cached similarly to the steps 306-308.

Resuming and completing rendering web page 310. After all the resources from the batch response are cached, the handler 202 sends the base page to the browser, if it was held on the step 303. Web browser 108 completes all steps of parsing base page and rendering DOM similarly to the prior art and retrieves resources required for rendering DOM from the client cache 109 or requests them from the caching module 203. The resources are loaded into the web browser separately despite the fact that they are received from the network 102 in the batch response combined.

In another embodiment subsequent base page requests are combined with the resource batch request to further reduce server roundtrips. On the first request to the web page after opening a new web browsers session, step 301-310 are executed, as described above, and the list of resources in all batch requests is stored in the handler 202. On the subsequent request of the same web page in the same browser session, the handler 202 converts the base page request into the batch request and adds to it all not cached or expired resources from the previous requests, stored on the first request. Such batch request is handled by the handler 201 as described in step 306-307. Then steps 308-310 are performed with the only modification that the base page is received from the batch response.

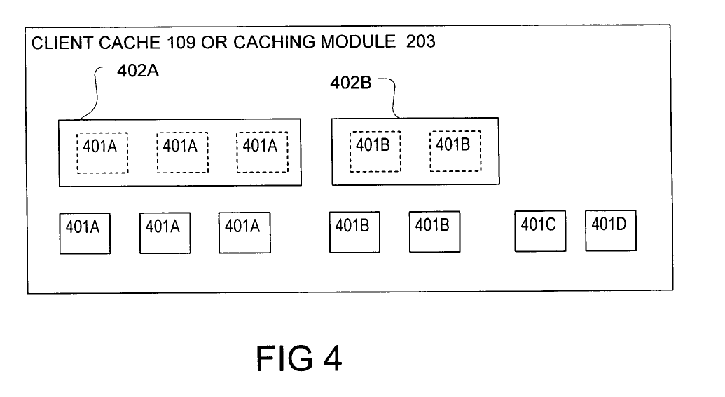

FIG. 4 shows how in another embodiment individual resources cached in the client cache 109 or caching module 203 are combined to speedup web page rendering in the web browser, reduce and expedite cache reads and accelerate receiving objects from the caching module. Multiple embedded into the web page resources of one type, for example scripts 401A, or style sheets 401B, are combined into a resulting aggregate resource of the same type, for example 402A or 402B, respectively, that are stored in the same cache.

Several steps are performed on the client 101 or on the client caching node 121 according to the method of the invention.
a) Determining a set of resulting aggregate resources. There are several known rules of combining resources on a web page [Steve Souders]. For example, only resources of the same type can be combined; the order of combining resources must be the same as the order of these resources in the base page.
b) Creating one-to-many associations between the aggregate resources and individual resources. Every individual resource can be included only in one aggregation. Some of the resources, for example 401C and 401D can remain un-aggregated.
c) Aggregating resources by reading them from the cache 109 or 203 and combining using one of known techniques, for example, concatenating and caching the resulting aggregate file.
d) Modifying references on the base page. Removing references to the individual resources and adding references to a smaller number of corresponding aggregate resources. As a result, references to all resources 401A and 401B are replaced with a reference to resource 402A or 402B.

In preferred embodiment steps a-d above are performed by the handler 202. While the modified base page is being parsed in the web browser 108, the fewer aggregated resources 402A and 402B are requested from the cache, compared to the original number of resources 401A and 401B. Consequently a fewer disk reads are performed and the web page is rendered faster. Only changed on the server individual resources have to be downloaded to the client and cache granularity is preserved. For comparison, in the prior art, as described above in the paragraph 0015, the same situation requires to download from the server the entire aggregate resource, that creates a higher level of network traffic.

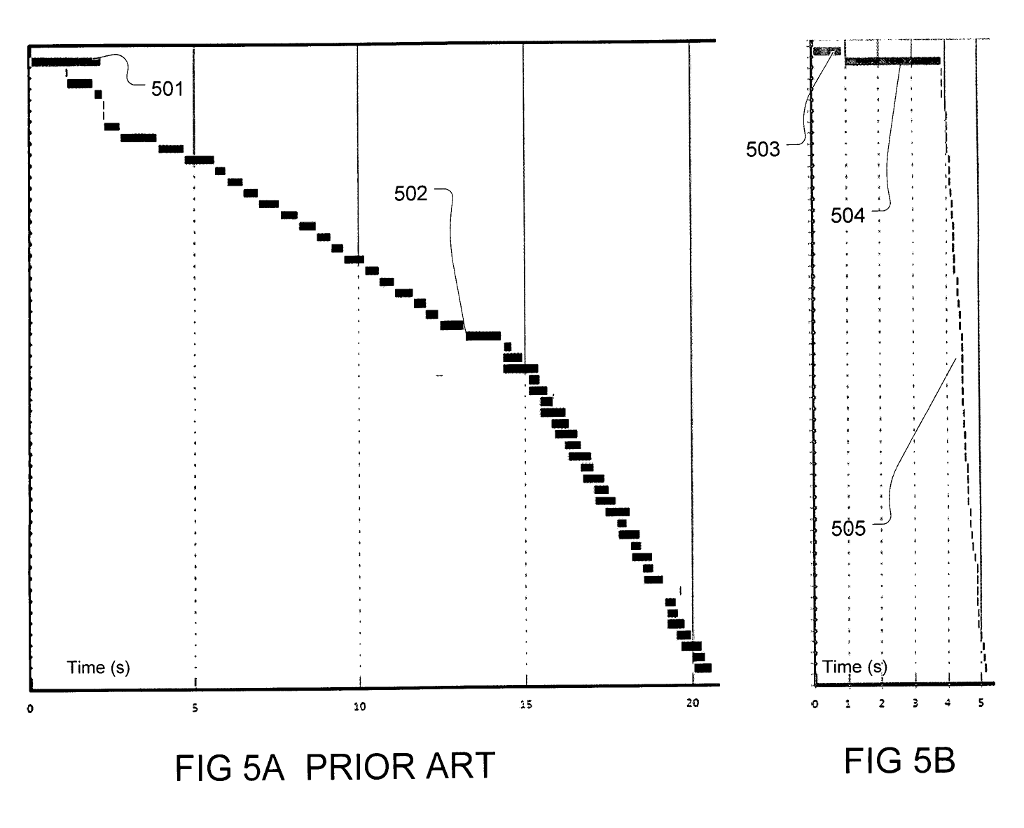

FIG. 5A shows a waterfall diagram of downloading a test page in the prior art with cleared client cache. The base page is requested and downloaded first, as shown by the bar 501. After that 55 resources are downloaded from the server. Their request response sequences are shown by multiple bars 502. The total download time exceeds 20 seconds.

FIG. 5B shows a waterfall diagram of downloading the same test page in preferred embodiment when the client cache is also cleared. The base page is requested and downloaded first, as shown by bar 503. Reduction of the base page download time (back end time) is achieved by using system and method described in the U.S. patent application Ser. No. 11/684,848. After that, a batch request/response sequence is complete, as shown by the bar 504. It results in caching all the individual resources on the client. And finally, the 55 resources are loaded to the web browser from the client cache avoiding multiple server roundtrips, as shown by the bars 505. The total download time in the invention slightly exceeds 5 seconds that presents substantial time savings comparing to the prior art.

While the invention has been described and illustrated in connection with preferred embodiments, many variations and modifications, as will be evident to those skilled in this art, may be made without departing from the spirit and scope of the invention, and the invention is thus not to be limited to the precise details of methodology or constitution set forth above as such variations and modifications are intended to be included within the scope of the invention.

1. Method of creating a web page in a web browser running on a client connected via a computer network with a server, said web page comprising a base page and optional one or more parent web documents, said method comprising the steps of:
sending a batch request containing a web address of each of a plurality A of at least two resources referenced by said base page;
sending a batch response containing a plurality B of at least two resources whose web addresses are received from the batch request; and
caching each of said plurality B of at least two resources separately after receiving the batch response.

2. The method of claim 1, further comprising:
including into the batch response HTTP response header information of at least some of said plurality B of at least two resources; and
caching said HTTP response header information in association with the associated resource.

3. The method of claim 1, wherein
said batch response includes resources of different types.

4. The method of claim 1, further comprising:
parsing on the client the base page and the parent web documents, if exist, to determine said web addresses of at least some of the plurality A of at least two resources.

5. The method of claim 1, further comprising:
monitoring the requests from the web browser originated by the base page to determine said web addresses of at least some of the plurality A of at least two resources.

6. The method of claim 1, wherein
the batch request contains cache versioning information of those of said plurality A of at least two resources that may be expired.

7. The method of claim 1, further comprising:
including into said batch response only those of said plurality B of at least two resources that are uncached or expired, as determined according to said cache versioning information.

8. The method of claim 1, further comprising:
transferring over the computer network the batch response containing combination of compressed and uncompressed said resources.

9. The method of claim 1, wherein
said batch request is formed on the client,
said batch response is formed on a network node,
the client is connected to said network node via a cellular network, and
said network node services to the client resources received from the Internet from a large number of servers.

10. System for creating a web page in a web browser running on a client connected via a computer network and an optional network node with a server, said web page comprising a base page, system comprising:
a batch request handler positioned on the server or on the network node and receiving a batch request containing at least two web addresses of resources referenced by said base page; and
a batch response handler receiving a batch response containing at least some of the resources,
wherein said at least some of the resources loaded into the web browsers separately.

11. The system of claim 10, wherein
the batch request includes web addresses of the resources that are uncached or may be expired and cache versioning information of the latter.

12. The system of claim 10, wherein
the batch response includes HTTP response header information for each of said at least some of the resources,
wherein at least some of said HTTP response header information is cached in association with the associated resource separately from the other resources.

13. The system of claim 10, wherein
the batch response containing resources of different types.

14. The system of claim 10, wherein
the batch response containing compressed and uncompressed resources.

15. The system of claim 10, wherein
said at least two web addresses in the batch request are determined by parsing the base page.

16. The system of claim 10, wherein
said batch request is formed on the client,
said batch response is formed on the network node,
the client is connected to the network node via a cellular network, and
said network node services resources received from the Internet from a large number of servers.

17. The system of claim 10, wherein
said batch request is formed on a caching node of a content delivery network.

18. Method for creating response in a web application to serve a web page comprising a base page, said method comprising the steps of:
receiving a batch request containing two or more web addresses referenced by said base page;
forming a batch response containing at least two resources whose web addresses are in the batch request;
sending the batch response; and
caching separately each of said at least two resources after receiving the batch response.

19. The method of claim 18, further comprising:
processing an individual request to every of said two or more web addresses; and
receiving a set of response headers for every of said individual requests.

20. The method of claim 19, wherein
said batch response includes resources of different types and said sets of response headers.
